(19) United States
(12) Patent Application Publication
(10) Pub. No.: US 2010/0031651 A1
(43) Pub. Date: Feb. 11, 2010

(54) Cyclic productive motion device

(76) Inventor: Salvator Spataro, Morwell (AU)

Correspondence Address: SALVATOR SPATARO, 44 THE BOULEVARD, MORWELL, 3840, AU

(21) Appl. No.: 12/583,869

(22) Filed: Aug. 28, 2009

(30) Foreign Application Priority Data
Aug. 19, 2003 (AU) 2003903329
Aug. 28, 2003 (AU) 2003904634
Feb. 18, 2004 (AU) 2004900781

(51) Int. Cl. F03B 17/02

(52) U.S. Cl. 60/495

(57) ABSTRACT

A submersible buoyancy motor has a water filled UP leg 2 and an air filled DOWN leg 4 joined by a transfer passage 8. The transfer passage has pneumatically operated gates 36, 38, 40, 42 which allow the buoyant floats 32 to move in a transfer sequence through the gates preferably one at a time to reach the exit of the passage where they rise intermittently and push against a star wheel 34. The gates regulate the feed of the floats into the passage.

In another version, pistons 16, 18 transfer the floats through the transfer passage against water pressure.

### FIELD OF THE INVENTION

This invention concerns devices for producing cyclic motion which make use of the different densities of air and water.

Buoyancy motors with endless chains are known. WO 98/53199 describes such a motor. The design of the seal through which the floats must pass from surrounding air to surrounding water presents problems.

### SUMMARY OF THE INVENTION

The apparatus aspect of the invention provides an immersible device for producing cyclic motion in multiple buoyant members, comprising a transfer passage capable of admitting buoyant members from an air filled area at an entry end to a liquid filled area at the exit end of the passage, an air filled magazine capable of presenting a chain of buoyant members to the entry of the transfer passage, an immersible guide extending from the exit of the transfer passage to the surface of the liquid, a feeder for the members capable of sending one or more members through the transfer passage from entry to exit, wherein the guide has a power take-off means driven by the buoyant members moving through the guide.

The magazine which may be a watertight passage which makes a watertight connection with the transfer passage and exceeds the capacity of the transfer passage. The immersible guide may be a tubular cage to allow the escape of liquid as the members rise through the liquid. The gate may be located at or near the surface of the liquid. The magazine may have an arrester which controls the admission of buoyant members to the entry of the transfer passage confining admission of a member or members to the induction phase of the feeder. The transfer passage is preferably cylindrical and the feeder comprises means defining a compartment for one or more members capable of moving a member or members from a position in register with a magazine to a position in register with a guide in order to allow release from the passage. The means confining the compartment for one or more members comprises a pair of pistons, each operated from one end of the passage.

The members may be spherical, cylindrical or of waisted cylindrical shape.

### BRIEF DESCRIPTION OF THE DRAWINGS

One embodiment of the invention is now described by way of example with reference to the accompanying drawings, in which:

FIG. 1 is a diagram of a first embodiment of the apparatus.

FIGS. 2-7 show the feed sequence of the transfer procedure.

FIG. 8 is a diagrammatic section of an alternative embodiment.

FIGS. 9-14 show the operating sequence of the embodiment of FIG. 8.

FIG. 15 is a diagrammatic section of a further embodiment included for immersion in an hydroelectric installation.

### DETAILED DESCRIPTION WITH RESPECT TO THE DRAWINGS

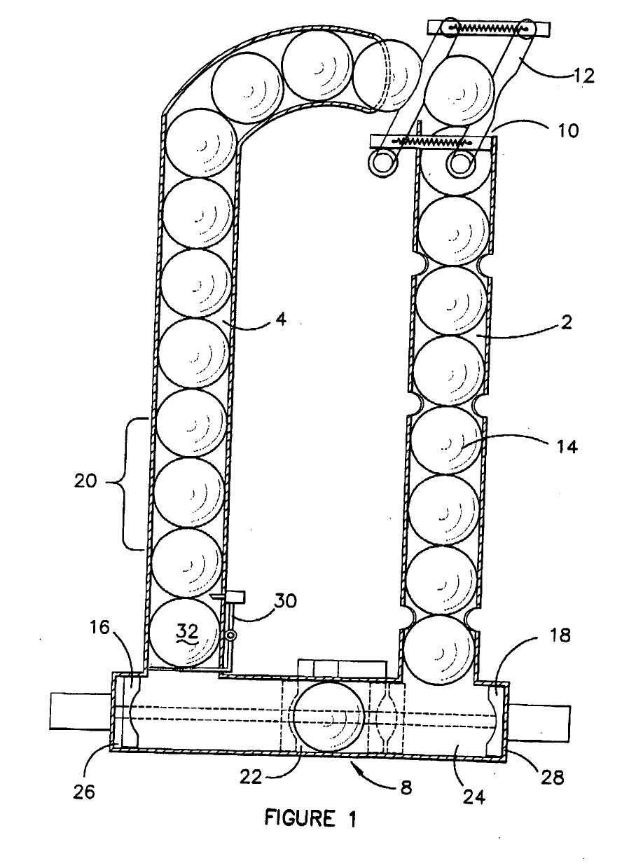

Referring now to FIG. 1, an inverted U-tube 2 has an UP leg 4 and a DOWN leg 6. The UP leg is a tubular cage which allows liquid to escape easily from it. The lower ends of the legs are joined by a transfer passage 8. At the beginning of the U-part there is a window 10 in the UP leg which gives access to the interior of the tube to a reciprocal gate 12.

The transfer passage 8 is cylindrical and it is intended to transfer hollow, air-filled metal spheres 14 from one leg to the other. As the UP leg is water filled and the DOWN leg is air-filled, a LH piston 16 and a RH piston 18 reciprocate cooperatively to cause the spheres 14 to move from the stack 20 in the DOWN leg into the intermediate space 22 between the tubes, to the release space 24 where the sphere is free to rise by buoyancy through the liquid in the UP leg. The pistons each occupy a recess 26, 28 at the ends of the passage. The RH piston return movement triggers trip 30 which only releases the lowermost sphere when the pistons separate to initiate the transfer.

If the device is immersed in a body of water such as a lake, the window is just above water level but the part shown in FIG. 1 below the window are immersed. The reciprocal gate is above water level and is placed near the top of the UP leg so as to harness both the UP thrust and the kinetic energy of the rising sphere. As the spheres rise they reciprocate the gate which may drive a display device or the like. The spheres are released in a chain into the DOWN leg and fall by gravity toward the transfer passage 8.

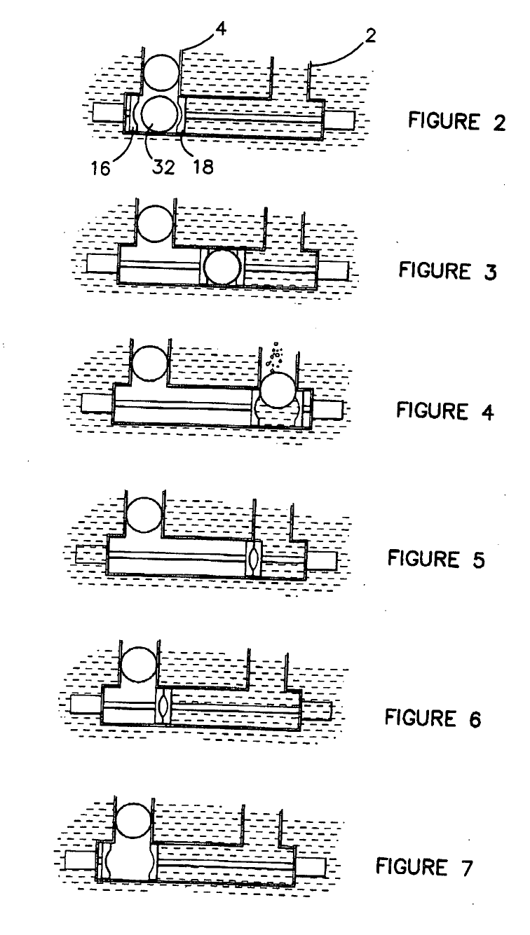

Referring now to FIGS. 2-7, the sequence of operation of the transfer passage is as follows.

In FIG. 2 the pistons 16, 18 lie in the positions shown allowing the stack to feed the lowermost sphere 32 into the entrance of the transfer passage which operates to transfer spheres from LEFT to RIGHT.

In FIG. 3 both pistons move RIGHT in unison, taking the lowermost sphere in a pocket of air into the intermediate space.

In FIG. 4 the pistons continue to move RIGHT in unison with a sphere lying between them until the sphere lies in register with the UP leg. The air in the air pocket is released into the UP leg followed by the sphere which rises. The space between the pistons is occupied by liquid. The gate is actuated by the surfacing sphere which rolls into the DOWN leg. Instead the gate may be a star wheel.

In FIG. 5 RH piston advances to the LH piston, displacing liquid between the pistons into the UP leg. The pistons close together expelling liquid into the UP leg and move in unison to the LEFT.

The pair stop at the position shown in FIG. 6 and the trip allows the lowermost sphere in the stack to fall into the entrance of the transfer passage. The cycle repeats.

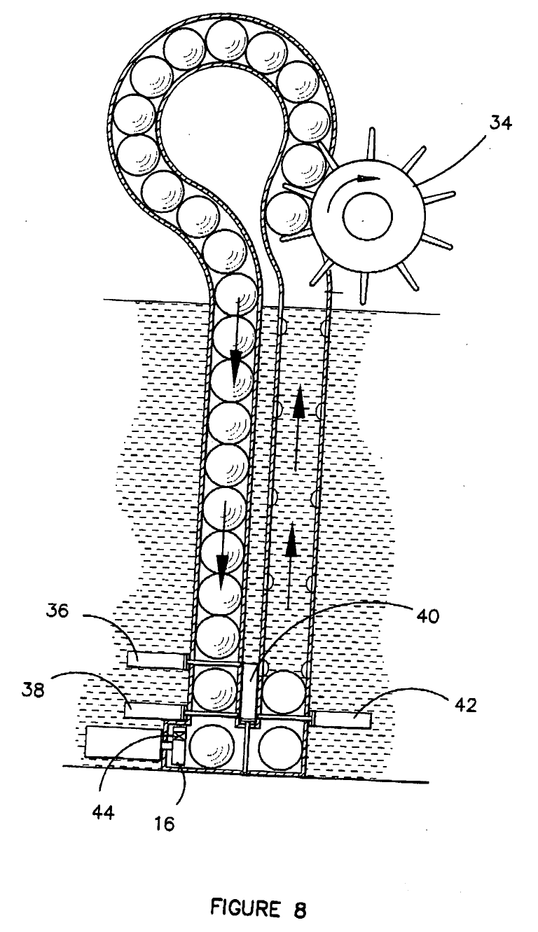

Referring now to FIG. 8, the transfer passage 8 is shortened and the reciprocable gate of the first embodiment is replaced by a star wheel 34.

Trip 30 is replaced by a pair of horizontal gates 36, 38. Ram 16 drives the spheres along the transfer passage as in the previous embodiment. The rise and fall gate 40 is ram operated as is exit gate 42. The rams are pneumatically operated from an electric compressor (not shown). The star wheel 34 revolves slowly because the transfer passage takes several seconds to transfer the sphere from air to water allowing for escape of air. The star wheel receives the impact of the up thrust of the rising sphere and drives a generator through a step up gear.

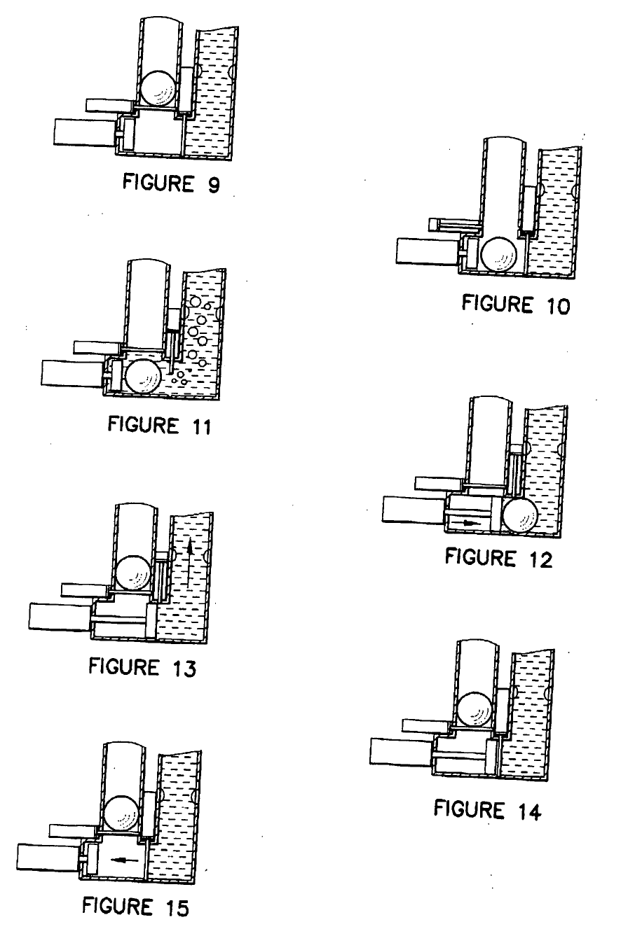

Referring now to FIGS. 9-15, the sequence begins when the lowermost sphere 32 is admitted by gate 38 into the transfer passage which is divided by the rise and fall gate. The DOWN leg is closed by gates 36, 38. When the gate 40 rises, water enters the passage and air leaves. The sphere rises but is forced to the RIGHT by advancing piston 16. This power stroke requires sufficient energy to refill about half the transfer passage with air. The sphere rises in the UP leg and imparts rotation to the star wheel. The rise and fall gate descends again dividing the passage. The gate and piston 16 lie together. When piston 16 retracts, a one way valve 44 in the piston allows air to flow into the space between the piston and the gate thereby preventing a partial vacuum. The space beneath the DOWN leg is full of air and ready to receive the next ball. The sequence repeats.

In FIG. 16, the device is intended to be partly submerged in a dam behind the dam wall. The transfer passage has an exit 42 to the star wheel through the UP leg and an exit through the gate 48 where water joins the generator tunnel 50 through the dam.

1. An immersible device for producing cyclic motion in multiple buoyant members, comprising a transfer passage capable of admitting buoyant members from an air filled area at an entry end to a liquid filled area at the exit end of the passage, an air filled magazine capable of presenting a chain of buoyant members to the entry of the transfer passage, an immersible guide extending from the exit of the transfer passage to the surface of the liquid, a feeder for the members capable of sending one or more members through the transfer passage from entry to exit, wherein the guide has a power take-off means driven by the buoyant members moving through the guide.

2. A device as claimed in claim 1, wherein the magazine is a watertight passage which makes a watertight connection with the transfer passage and exceeds the capacity of the transfer passage.

3. A device as claimed in claim 1 or 2, wherein the immersible guide is a tubular cage to allow the escape of liquid as the members rise through the liquid.

4. A device as claimed in any one of claims 1-3, wherein the gate is located at or near the surface of the liquid.

5. A device as claimed in any one of claims 1-4, wherein the magazine has an arrester which controls the admission of buoyant members to the entry of the transfer passage confining admission of a member or members to the induction phase of the feeder.

6. A device as claimed in any one of claims 1-5, wherein the transfer passage is cylindrical and the feeder comprises means defining a compartment for one or more members capable of moving a member or members from a position in register with a magazine to a position in register with a guide in order to allow member release from the passage.

7. A device as claimed in claim 6, wherein the means confining the compartment for one or more members comprises a pair of pistons, each operated from one end of the passage.

8. A device for producing cyclic motion in multiple buoyant members, comprising an upright guide for the members capable of filling with liquid, having an inlet at the lower end and an outlet at the upper end, a liquid seal at the inlet capable of admitting one or more buoyant members, a feeder capable of moving one or more members through the liquid seal from a magazine, the magazine being arranged to receive members released to the guide.

9. A device as claimed in any one of the preceding claims, wherein the power take-off means is a star wheel.

10. A device for producing cyclic motion in multiple buoyant members substantially as herein described with reference to and as illustrated in FIGS. 1-7 or as modified by FIGS. 8-15.
